(19) United States
(12) Patent Application Publication
(10) Pub. No.: US 2014/0218673 A1
(43) Pub. Date: Aug. 7, 2014

(54) LIQUID CRYSTAL PANEL, LIQUID CRYSTAL PANEL AGGREGATE, AND MANUFACTURING METHOD FOR LIQUID CRYSTAL PANEL

(71) Applicants: Hiroki Makino, Osaka (JP); Takatoshi Kira, Osaka (JP)

(72) Inventors: Hiroki Makino, Osaka (JP); Takatoshi Kira, Osaka (JP)

(73) Assignee: SHARP KABUSHIKI KAISHA, Osaka (JP)

(21) Appl. No.: 14/114,110

(22) PCT Filed: May 2, 2012
(86) PCT No.: PCT/JP2012/061589

§ 371 Date: Oct. 25, 2013

(30) Foreign Application Priority Data
May 9, 2011 (JP) 2011-104471

(51) Int. Cl. G02F 1/1339; G02F 1/1333

(52) U.S. Cl. CPC G02F 1/1339; G02F 1/1333
USPC 349/153; 445/24

(57) ABSTRACT

A liquid crystal panel (10) of the present invention is provided with: a liquid crystal layer (50); a sealing member (40) surrounding the liquid crystal layer (50); a pair of glass substrates (20, 30) that face each other through the liquid crystal layer (50) and the seal member (40); a terminal pattern (60) disposed on the inner surface of one glass substrate (20) outside of the sealing member (40); and a corrosive liquid intrusion detector (70) that is disposed on the inner surface outside of the terminal pattern (60), the corrosive liquid intrusion detector changing color on contact with corrosive liquid. Because of such color change in the corrosive liquid intrusion detector, it is possible to detect corrosion of the terminal pattern.

### TECHNICAL FIELD

The present invention relates to a liquid crystal panel, a group of liquid crystal panels, and a manufacturing method for a liquid crystal panel.

### BACKGROUND ART

In recent years, liquid crystal panels are widely used as a display unit for home electronics such as computers and televisions. Typically, a liquid crystal panel has a configuration in which a thin film transistor (TFT) array substrate and a color filter (CF) substrate, i.e., a pair of substrates, are bonded in parallel with each other with a prescribed gap therebetween, and liquid crystal is sealed between the two substrates.

Generally, in the TFT array substrate, a plurality of TFTs and pixel electrodes connected thereto are formed in a matrix. In the CF substrate, color filters are formed in a matrix, and a common electrode is formed over the entire surface thereof, and by changing a voltage applied between these electrodes, the orientation of the liquid crystal can be controlled.

In manufacturing such a liquid crystal panel, liquid crystal panels are processed as a mother substrate (a large glass substrate for making a plurality of liquid crystal panels) up to the middle of the manufacturing process, such as forming pixel electrodes and CFs for a plurality of liquid crystal panels on the large mother substrate.

For small liquid crystal panels used in mobiles phones, digital cameras, and the like, several mother substrates are put together to make a large panel, which thereafter is divided into individual panels.

In recent years, in particular, the above-mentioned small liquid crystal panels are required to have a thinner profile and a narrower frame to achieve a lighter panel and a larger screen. The thinner profile in this case is achieved by reducing the thickness of the substrates constituting the liquid crystal panel, which specifically are the TFT array substrate having the pixel electrodes and the like formed thereon and the CF substrate having the CFs and the like formed thereon, as described above. The narrower frame means that the area of the display region of the liquid crystal panel is enlarged, or in other words, the area of a panel frame region surrounding the display region is reduced.

Patent Document 1 discloses a technology for thickness reduction. Specifically, a group of TFT array substrates and a group of CF substrates are bonded to each other through sealing members formed so as to surround the respective display regions, and by providing liquid crystal layers respectively in a plurality of display regions between the groups of substrates, a group of panels (large panel) is created.

Next, by etching the group of panels by using an etching solution made of hydrofluoric acid or the like, the respective groups of substrates are thinned. In such an etching process, the group of panels is immersed in the etching solution stored in an etching tank.

Thereafter, scribed grooves are formed in the respective groups of substrates using a cutting wheel having a rotary blade or the like, and by dividing the group of panels along the scribed grooves, a plurality of liquid crystal panels are obtained.

With this method, the respective groups of substrates can be made thinner in the state of the group of panels, and as compared with the case in which each liquid crystal panel is made thinner after division, for example, a higher manufacturing efficiency can be achieved.

However, in some cases, it is difficult to divide the thinned group of panels precisely to a prescribed panel outer dimension, as compared with the case in which a group of panels before thinning is divided.

Patent Document 2 discloses a technology for precisely dividing a group of panels after thinning, thereby achieving the thickness reduction of the liquid crystal panels.

### RELATED ART DOCUMENTS

### Patent Documents

Patent Document 1: Japanese Patent Application Laid-Open Publication No. H4-116619

Patent Document 2: Japanese Patent Application Laid-Open Publication No. 2007-298747

### Problems to be Solved by the Invention

However, when conducting chemical etching on a large panel in which a scribed groove is formed, in some cases, a penetrating hole is formed in a mother substrate as a result of the scribed groove growing too deep, or the like. If such a hole is formed, the etching solution enters the inside of the mother substrate through the hole, causing corrosion of terminal patterns formed on an inner surface of the TFT array substrate.

Corrosion of the terminal patterns causes connection defects and the like, which makes a portion of the liquid crystal panel where the corroded terminal pattern is disposed unusable. The terminal pattern is generally made of a plurality of fine wiring lines, and therefore, even if only a portion thereof is corroded due to the etching solution, it is not always possible to detect (find) the corroded portion visually, which poses a problem.

### SUMMARY OF THE INVENTION

An object of the present invention is to provide a technology for detecting a liquid crystal panel having a corroded terminal pattern due to an etching solution (corrosive liquid) with ease, when reducing the thickness of substrates constituting the liquid crystal panel with chemical etching.

### Means for Solving the Problems

A liquid crystal panel of the present invention includes: a liquid crystal layer; a sealing member surrounding the liquid crystal layer; a pair of glass substrates facing each other through the liquid crystal layer and the sealing member; a terminal pattern disposed outside of the sealing member on an inner surface of one of the glass substrates; and a corrosive liquid intrusion detector disposed outside of the terminal pattern on the inner surface, the corrosive liquid intrusion detector changing color on contact with a corrosive liquid. In the liquid crystal panel, it is possible to detect corrosion of the terminal pattern by the discoloration of the corrosive liquid intrusion detector.

In the liquid crystal panel, the corrosive liquid intrusion detector may include a metal film.

In the liquid crystal panel, the corrosive liquid intrusion detector may include a metal film and a base film laid under the metal film. In the liquid crystal panel, because the base film is provided under the metal film, it becomes easier to detect discoloration of the corrosive liquid intrusion detector.

In the liquid crystal panel, the corrosive liquid intrusion detector may include a metal film, a base film, and one intermediate film or two or more intermediate films interposed therebetween. In the liquid crystal panel, because the metal film, the base film, and one intermediate film or two or more intermediate films interposed therebetween are provided, it becomes easier to detect discoloration of the corrosive liquid intrusion detector.

In the liquid crystal panel, the metal film may be made of the same material as a transparent electrode disposed on an inner surface of one of the glass substrates, and may be formed in the same forming step as the transparent electrode. In the liquid crystal panel, because the metal film is formed in the same forming step as the transparent electrode, a higher manufacturing efficiency can be achieved.

In the liquid crystal panel, the base film may be made of the same material as an insulating film disposed on an inner surface of one of the glass substrates, and may be formed in the same forming step as the insulating film. In the liquid crystal panel, because the base film is formed in the same forming step as the insulating film, a higher manufacturing efficiency can be achieved.

In the liquid crystal panel, the intermediate film may be made of the same material as a gate electrode or a source electrode disposed on an inner surface of one of the glass substrates, and may be formed in the same forming step as the gate electrode or the source electrode. In the liquid crystal panel, because the intermediate film is formed in the same forming step as the gate electrode or the source electrode, a higher manufacturing efficiency can be achieved.

In the liquid crystal panel, the corrosive liquid intrusion detector may surround the terminal pattern together with the sealing member. In the liquid crystal panel, because the corrosive liquid intrusion detector surrounds the terminal pattern together with the sealing member, it is possible to reliably detect the intrusion of an etching solution.

A group of liquid crystal panels according to the present invention is a group of liquid crystal panels for manufacturing a plurality of the liquid crystal panels at the same time, the group of liquid crystal panels including: one mother glass substrate made of a plurality of one type of glass substrates interconnected to each other; another mother glass substrate made of a plurality of another type of glass substrates interconnected to each other; a plurality of liquid crystal layers interposed between the mother glass substrates; a plurality of sealing members interposed between the mother glass substrates; a plurality of terminal patterns disposed on an inner surface of the one mother glass substrate; and a plurality of corrosive liquid intrusion detectors disposed on the inner surface of the one mother glass substrate.

A manufacturing method for a liquid crystal panel according to the present invention includes: forming a scribed groove on an outer surface of at least one of mother glass substrates for dividing the group of liquid crystal panels into individual liquid crystal panels; exposing the scribed groove to a corrosive liquid to make the scribed groove larger; dividing the group of liquid crystal panels into individual liquid crystal panel along the scribed groove that has been made larger; and removing, from the divided liquid crystal panels, a liquid crystal panel in which a corrosive liquid intrusion detector has discolored due to the corrosive liquid.

### Effects of the Invention

According to the present invention, it is possible to provide a technology for detecting a liquid crystal panel having a terminal pattern corroded due to an etching solution (corrosive liquid) with ease, when reducing the thickness of substrates constituting the liquid crystal panel with chemical etching.

### BRIEF DESCRIPTION OF THE DRAWINGS

FIG. 1 is a cross-sectional view of a liquid crystal panel.

FIG. 2 is a plan view of a liquid crystal panel.

FIG. 3 is a cross-sectional view of a corrosive liquid intrusion detector.

FIG. 4 is a plan view of a group of liquid crystal panels.

FIG. 5 is a flowchart for explaining steps of a manufacturing method for liquid crystal panels.

FIG. 6 is a cross-sectional view schematically showing an area around a sealing member in a group of liquid crystal panels before thinning.

FIG. 7 is a cross-sectional view of an etching tank used for thinning the group of liquid crystal panels.

FIG. 8 is a cross-sectional view schematically showing an area around the sealing member of the group of liquid crystal panels that has been thinned by a first etching process.

FIG. 9 is a perspective view of a cutter wheel used to form a scribed groove.

FIG. 10 is a cross-sectional view schematically showing an area around the sealing member in the group of liquid crystal panels in which a first scribed groove is formed.

FIG. 11 is a cross-sectional view schematically showing an area around the sealing member in the group of liquid crystal panels that has been thinned by a second etching process.

FIG. 12 is a cross-sectional view schematically showing an area around the sealing member in the group of liquid crystal panels in which a second scribed groove is formed.

FIG. 13 is a cross-sectional view schematically showing liquid crystal panels obtained by dividing the group of liquid crystal panels.

FIG. 14 is a plan view of a liquid crystal panel of Embodiment 2.

FIG. 15 is a plan view of a group of liquid crystal panels of Embodiment 2.

FIG. 16 is an enlarged plan view of a part of a corrosive liquid intrusion detector formed in a liquid crystal panel of Embodiment 3.

FIG. 17 is an enlarged cross-sectional view of a part of a corrosive liquid intrusion detector formed in a liquid crystal panel of Embodiment 4.

FIG. 18 is an enlarged cross-sectional view of a part of a corrosive liquid intrusion detector formed in a liquid crystal panel of Embodiment 5.

### DETAILED DESCRIPTION OF EMBODIMENTS

### Embodiment 1

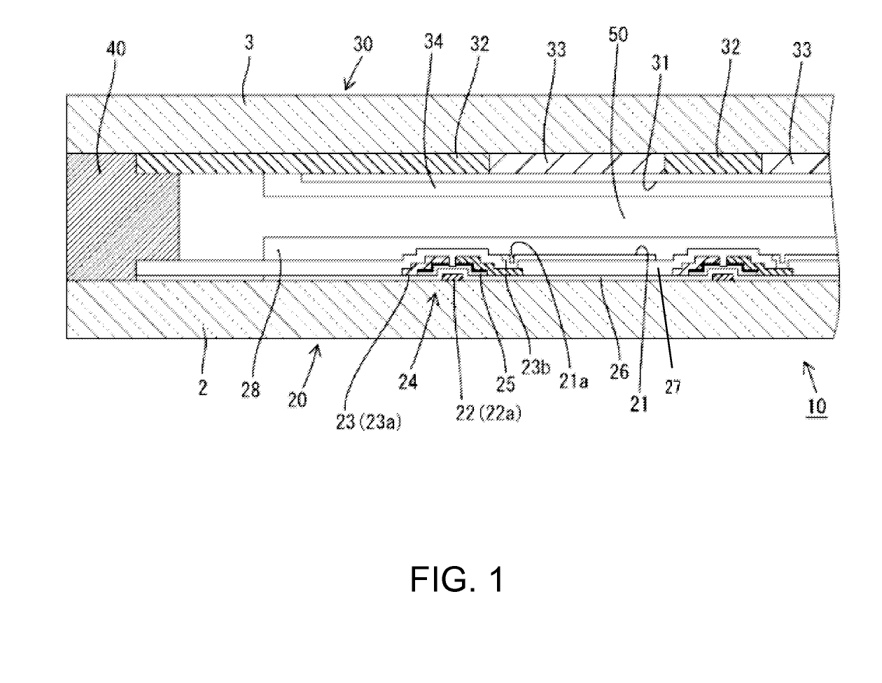

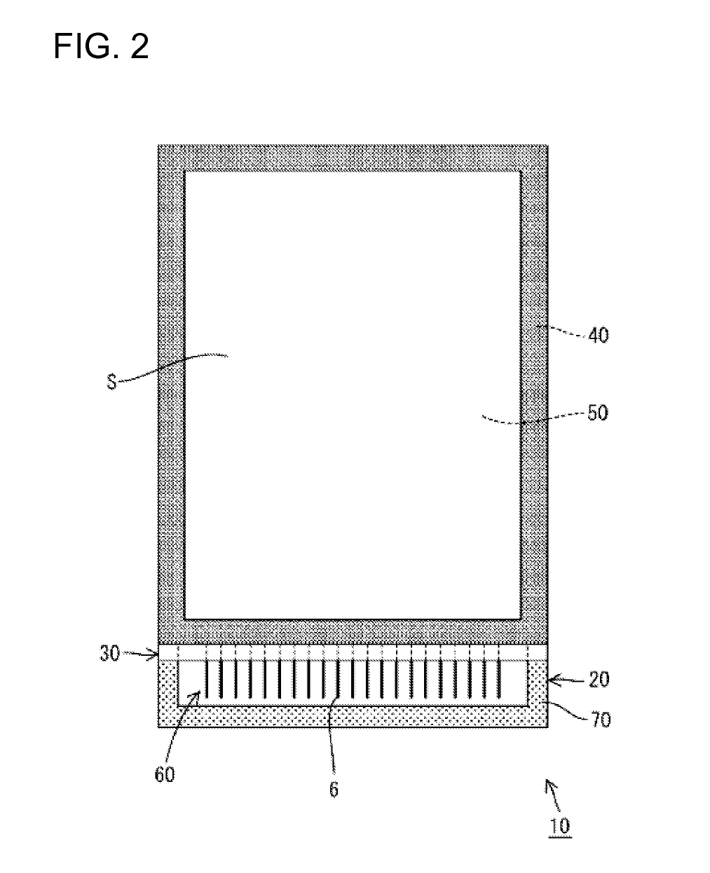

A manufacturing method for a liquid crystal panel according to one embodiment of the present invention, a group of liquid crystal panels used in the manufacturing method, and a liquid crystal panel obtained by this manufacturing method will be explained with reference to FIGS. 1 to 13. First, with reference to FIGS. 1 and 2, a configuration of a liquid crystal panel of the present embodiment will be explained.

(Liquid Crystal Panel)

FIG. 1 is a cross-sectional view of a liquid crystal panel 10. As shown in FIG. 1, the liquid crystal panel 10 mainly includes a TFT array substrate (one example of a glass substrate) 20, a CF substrate (one example of a glass substrate) 30, a sealing member 40, a liquid crystal layer 50, and the like.

In the TFT array substrate 20, a plurality of pixel electrodes (transparent electrodes) 21 are formed in a matrix on a transparent glass plate 2. Around the respective pixel electrodes 21, gate electrode lines 22 that are scanning electrode lines, and source electrode lines 23 that are image signal electrode lines are formed so as to intersect with each other.

The gate electrode lines 22 and the source electrode lines 23 are disposed such that the source electrode lines 23 are above the gate electrode lines 22 at the respective intersections thereof. The gate electrode lines 22 and the source electrode lines 23 are electrically insulated from each other through a gate insulating film 26 at the respective intersections. A TFT 24 that is a switching element is formed for each of the intersections of the gate electrode lines 22 and the source electrode lines 23. Each TFT 24 is connected to a gate electrode 22a that is a part of a gate electrode line 22.

A semiconductor film 25 is formed above the gate insulating film 26 in a region where the TFT 24 is formed so as to overlap the gate electrode 22a. On the semiconductor film 25, a source electrode 23a that is a part of a source electrode line 23, and a drain electrode 23b are respectively formed. The source electrode 23a and the drain electrode 23b are formed on the semiconductor film 25 so as to have a gap therebetween, and the gate electrode 22a is disposed between the two. The drain electrode 23b is connected to a pixel electrode 21 through a contact hole 21a in the pixel electrode 21.

The TFT 24 is turned on and off by a scanning signal voltage supplied from the gate electrode 22a of the gate electrode line 22. An image signal voltage supplied from the source electrode 23b of the source electrode line 23 is supplied through the TFT 24 in the ON state to the drain electrode 23b and further to the pixel electrode 21 through the contact hole 21a.

The TFT 24 is covered by an interlayer insulating film 27 formed above the gate insulating film 26. On the interlayer insulating film 27, the pixel electrodes 21 are formed. The pixel electrodes 21 are formed of a transparent conductive film such as ITO (indium tin oxide), for example. On the pixel electrodes 21, an alignment film 28 is formed of a polyimide film or the like that underwent an alignment treatment using UV light or the like. The orientation of the liquid crystal substance included in the liquid crystal layer 50 is controlled by this alignment film 28.

The CF substrate 30 is disposed to face the TFT array substrate 20, and the liquid crystal layer 50 is interposed between the CF substrate 30 and the TFT array substrate 20. In the CF substrate 30, a grid-shaped black matrix (BM) 32 is formed on a transparent glass plate 3 so as to prevent light from entering regions where the above-mentioned gate electrode lines 22 and source electrode lines 23 are formed. In the respective regions surrounded by the BM 32, CF layers (colored layers) 33 of red, blue, green, and the like are formed.

A common electrode 31 facing the respective pixel electrodes 21 of the TFT array substrate 20 is formed so as to cover the surfaces of the CF layers 33 and the BM 32. In FIG. 1, the common electrode 31 is shown to be below the CF layers 33 and the BM 32. The common electrode 31 is also formed of a transparent conductive film such as ITO, as in the pixel electrodes 21. An alignment film 34 is formed so as to cover the surface of the common electrode 31. The alignment film 34 is also made of a polyimide film or the like that underwent the alignment treatment using UV light or the like, as in the alignment film on the TFT array substrate 20, and controls the orientation of the liquid crystal substance included in the liquid crystal layer 50.

The liquid crystal layer 50 interposed between the two substrates 20 and 30 is sealed by the sealing member 40. As shown in FIG. 1, the sealing member 40 is also interposed between the two substrates 20 and 30. FIG. 2 is a plan view of the liquid crystal panel 10. As shown in FIG. 2, the sealing member 40 is formed in a frame shape surrounding the liquid crystal layer 50. FIG. 2 shows the liquid crystal panel 10 viewed from the side where the CF substrate 30 is disposed.

As shown in FIG. 2, the TFT array substrate 20 and the CF substrate 30 are both in a rectangular shape (quadrangular shape). However, the TFT array substrate 20 disposed on the lower side of FIG. 2 is larger than the CF substrate 30 disposed on the upper side. The TFT array substrate 20 and the CF substrate 30 are disposed such that respective one shorter ends are aligned to each other. Respective other shorter ends are at different positions, and a part of the TFT array substrate 30 protrudes to the outside beyond the CF substrate 20. On an inner surface of the TFT array substrate 30 in this protruding portion, a terminal pattern 60 is formed. This terminal pattern 60 includes a plurality of fine wiring lines made of a metal material such as aluminum. On the terminal pattern 60, a not shown driver IC for driving the liquid crystal panel 10 is mounted.

The terminal pattern 60 is formed outside of the sealing member 40 on the inner surface of the TFT array substrate 20. In the present embodiment, the terminal pattern 60 is formed on the glass plate 2, and a portion thereof is covered by a shorter side edge of the CF substrate 30. Respective one ends of the wiring lines 6 constituting this terminal pattern 60 are connected to the source electrode lines 22, the gate electrode lines 23, and the like, described above. On the other hand, the respective other ends thereof are connected to terminals of a not-shown flexible printed circuit (FPC) through an anisotropic conductive film (ACF). The terminal pattern 60 is not formed at an edge of the TFT array substrate 20, and is disposed inside of the edge.

A corrosive liquid intrusion detector 70 is formed outside of the terminal pattern 60 on the inner surface of the TFT array substrate 20. As shown in FIG. 2, the corrosive liquid intrusion detector 70 is disposed along the edges of the TFT array substrate 20 so as to surround the terminal pattern 60. The corrosive liquid intrusion detector 70 is in a continuous band shape (line shape), and the width thereof is set wider than that of the respective wiring lines 6 constituting the terminal pattern 70. In the present embodiment, the width thereof is set slightly narrower than the width of the sealing member 40. The terminal pattern 60 is surrounded by the sealing member 40 and the corrosive liquid intrusion detector 70 on the inner surface of the TFT array substrate 20.

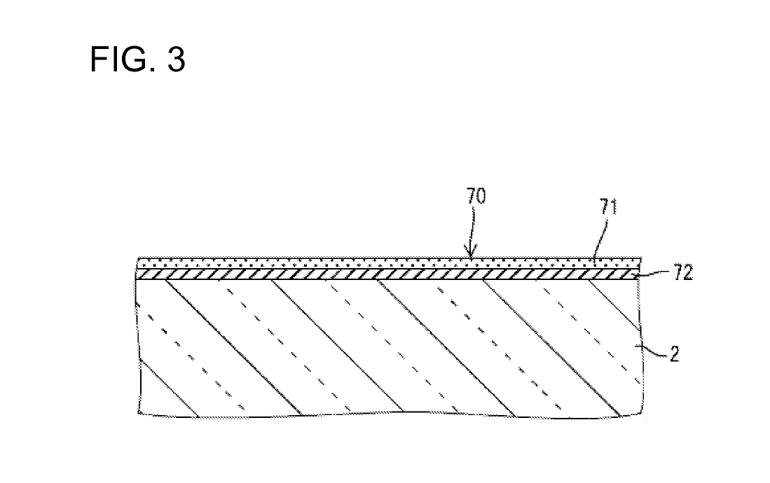

FIG. 3 is a cross-sectional view of the corrosive liquid intrusion detector 70. As shown in FIG. 3, the corrosive liquid intrusion detector 70 is made of a base film 72 formed on the glass plate 2 and a metal film 71 formed on the base film 72. The base film 72 is made of the same material as the gate insulating film 26, and is formed in the same manufacturing step as the gate insulating film 26. The metal film 71 is made of the same material as the above-mentioned pixel electrodes (transparent electrodes) 21 (or in other words, a transparent conductive film such as ITO), and is formed in the same manufacturing step as the pixel electrodes 21.

The corrosive liquid intrusion detector 70 is formed in a prescribed location by using a pattern forming technology such as photolithography. On contact with an etching solution (corrosive liquid) made of hydrofluoric acid or the like, the corrosive liquid intrusion detector 70 reacts with the etching solution and discolors.

(Group of Liquid Crystal Panels)

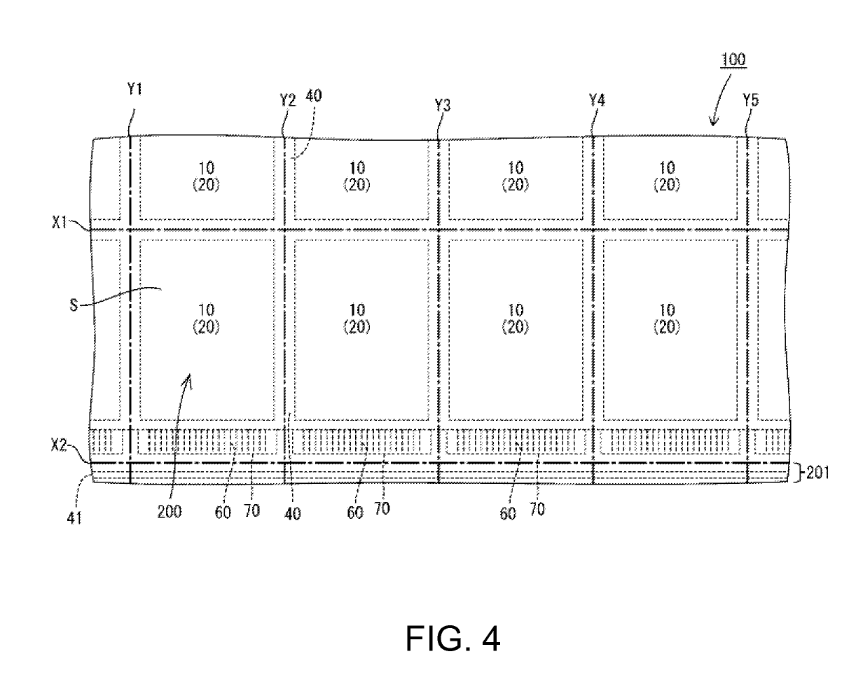

In the present embodiment, a plurality of liquid crystal panels 10 are manufactured at the same time as a large panel. FIG. 4 is a plan view of a group of liquid crystal panels 100. Here, the group of liquid crystal panels 100 will be explained with reference to FIG. 4 and the like.

As shown in FIG. 4, in the group of liquid crystal panels 100 as a large panel, a plurality of liquid crystal panels 10 are aligned and interconnected to each other. The respective TFT array substrates 20 of the respective liquid crystal panels 10 are manufactured at the same time as a large glass substrate (first mother glass substrate). The first mother glass substrate may be referred to as a group of TFT array substrates in particular. The respective CF substrates 30 of the respective liquid crystal panels 10 are also manufactured at the same time as a large glass substrate (second mother glass substrate). The second mother glass substrate may be referred to as a group of CF substrates in particular. When these mother glass substrates are bonded to each other with the liquid crystal layers 50, the sealing members 40, and the like therebetween, as described below, the group of liquid crystal panels 1 shown in FIG. 4 is obtained.

The respective liquid crystal panels 10 are partitioned by a plurality of dividing lines X1, X2, Y1, Y2, Y3, Y4, and Y5 that are provided, as imaginary lines, on the surface of the group of liquid crystal panels 100 (or in other words, on the outer surface of a mother glass substrate). As described below, scribed grooves are formed respectively along these dividing lines X1 and the like. FIG. 4 shows the group of liquid crystal panel 100 viewed from a mother glass substrate 200 side where the TFT array substrates 20 are formed. In a similar manner, a plurality of dividing lines are provided on a mother glass substrate 300 side where the CF substrates 20 are formed.

(Manufacturing Method for Liquid Crystal Panel)

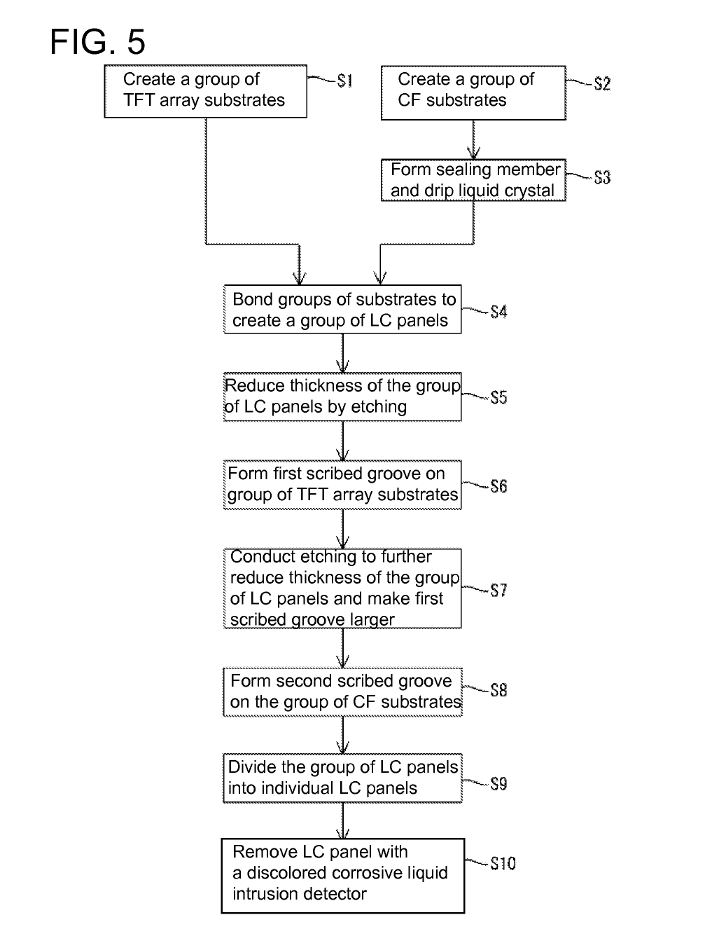

FIG. 5 is a flowchart for explaining steps of the manufacturing method for the liquid crystal panel 10. As shown in FIG. 5, the liquid crystal panel 10 is manufactured through step S1 to step S10. Below, the manufacturing method for the liquid crystal panel 10 will be explained for each step.

(Step S1)

Step S1 is a step to create a group of TFT array substrates. In step S1, first, on a large transparent glass plate (first mother glass plate), a conductive film of a single layer or multiple layers is formed of tungsten, titanium, aluminum, chromium, or the like. A known method such as sputtering can be used for the method to form the conductive film. The conductive film disposed on the plate is patterned into a desired shape by photolithography or the like. This way, gate electrode lines 22 and gate electrodes 22a formed in a prescribed pattern are obtained. The terminal patterns 60 are also formed in prescribed locations of the plate (first mother glass plate) in the same manufacturing process as the gate electrode lines 22 and the like.

Next, on the large glass plate on which the gate electrode lines 22 and the like are formed, a gate insulating film 26 is formed. The gate insulating film 26 is formed of silicon nitride or the like, for example, and is deposited by using a known method such as the plasma CVD method. The base film 72 of the corrosive liquid intrusion detector 70 is formed at the same time as forming this gate insulating film 26. On the gate insulating film 26, semiconductor films 25, source electrode lines 23, source electrodes 23a, and drain electrodes 23b are respectively formed. The semiconductor film 25 is made of an n+ type amorphous silicon or the like, for example, and is deposited by a known method such as the plasma CVD method. The source electrode lines 23, the source electrodes 23a, and the drain electrodes 23b are respectively formed by a method similar to that for the gate electrode lines 22 described above.

Next, an interlayer insulating film 27 made of a photosensitive resin is formed on the glass plate. In the interlayer insulating film 27, openings for providing contact holes 21a are formed. The openings are formed by photolithography or the like. On the surface of the interlayer insulating film 27, a transparent conductive film made of ITO is formed by a known method such as sputtering. Thereafter, the transparent conductive film is formed into a desired pattern by photolithography or the like, thereby forming pixel electrodes 21. In this manner, the pixel electrodes 21 having a prescribed pattern and the contact holes 21a are obtained. The metal film 71 of the corrosive liquid intrusion detector 70 is formed at the same time as forming the pixel electrodes 21. The metal film 71 is made of the same material as the pixel electrodes 21, which is ITO.

After the pixel electrodes 21 are formed, an alignment film 28 is formed so as to cover the pixel electrodes 21 and the like. A liquid material for the alignment film made of polyimide or the like is coated by using a cylinder-type printing apparatus, an inkjet printing apparatus, or the like. Thereafter, the coated material for the alignment film is dried, and the alignment treatment is conducted by irradiating the alignment film material with UV light from a prescribed direction. In this manner, the alignment film 28 is formed on the pixel electrodes 21.

As described above, in step S1, the group of TFT array substrates (first mother glass substrate) 200 is created in which a plurality of TFT array substrates 20 are aligned and interconnected to each other. At prescribed locations of each TFT array substrate 20, not-shown columnar spacers are formed. With this spacers, the gap between the TFT array substrate 20 and the CF substrate 30 is maintained after the two substrates are bonded to each other.

(Step S2)

Step S2 is a step to create a group of CF substrates. In step S2, first, a large transparent glass plate (second mother glass substrate) is coated with BM resist or the like. The BM resist is made of a photosensitive resin composition in which a black colorant is dispersed, or the like. Next, the coated BM resist is formed into a prescribed pattern by photolithography or the like. This way, a BM 32 having a prescribed pattern is formed on the plate (second mother glass substrate).

Next, the plate is coated with a colored photosensitive material of each color such as red, green, or blue. The colored photosensitive material is made of a photosensitive resin composition in which a colorant (pigment) of a prescribed color is dispersed, or the like. The coated colored photosensitive material is formed into a prescribed pattern by photolithography or the like. In this manner, CF layers (colored layers) 33 of a prescribed pattern are obtained. Next, a transparent conductive film made of ITO is formed by sputtering or the like so as to cover the CF layers 33, the BM 32, and the like. This transparent conductive film becomes a common electrode 31.

Next, an alignment film 34 is formed so as to cover the common electrode 31. The alignment film 34 is formed in a manner similar to the alignment film formed on the TFT array substrate 20 (the group of TFT array substrates 200).

As described above, in step S2, the group of CF substrates (second mother glass substrate) 300 is created in which a plurality of CF substrates 30 are aligned and interconnected to each other.

(Step S3)

Step S3 is a step to form respective sealing members 40 and to drip a liquid crystal material on the respective CF substrates 30 in the group of CF substrates 300. Each sealing member 40 is made of a thermosetting resin or a photocurable resin. The sealing members 40 are respectively formed in a frame shape surrounding the respective alignment films 34 on the inner surface of the respective CF substrates 30 by using a screen printing apparatus or the like. The liquid crystal material is dripped in respective areas inside of the sealing members 40 formed in a frame shape by using an inkjet injection apparatus or the like.

(Step S4)

Step S4 is a step to create the group of liquid crystal panels 100 by bonding the respective groups of substrates 200 and 300 to each other. In step S4, the group of TFT array substrates 200 and the group of CF substrates 300 having the sealing members 40 and the like formed thereon are disposed to face each other in a vacuum chamber (not shown). The respective groups of substrates 200 and 300 are pressurized in a reduced pressure state lower than the atmospheric pressure. Thereafter, when the atmospheric pressure is restored in the vacuum chamber, a pressure is constantly applied to the group of TFT array substrates 200 and the group of CF substrates 300 due to a difference between the atmospheric pressure and the internal pressure therebetween. Next, the respective sealing members 40 interposed between the respective groups of substrates 200 and 300 are cured. In this way, the group of TFT array substrates 200 and the group of CF substrates 300 are bonded to each other. When the bonding is completed, the group of liquid crystal panels 100 is obtained as shown in FIG. 4 in which the plurality of liquid crystal panels 10 are aligned and interconnected to each other.

As shown in FIG. 4, in the group of liquid crystal panels 100, liquid crystal panels 10 having a rectangular outer shape are disposed adjacent to each other. The sealing members 40 are formed as a large grid-shape pattern that surrounds respective display regions S of the respective liquid crystal panels 10. In other words, adjacent sealing members 40 are connected to each other in portions thereof. Each of the above-mentioned dividing lines X1, Y1, and the like is provided so as to go through substantially the center of the connected portion between adjacent sealing members 40.

As shown in FIG. 4, the respective terminal patterns 60 disposed on the inner surfaces of the respective TFT array substrates 20 are aligned along one line. The respective corrosive liquid intrusion detectors 70 disposed to surround the respective terminal patterns 60 are formed along the dividing lines X2, Y1, and the like. In the present embodiment, adjacent corrosive liquid intrusion detectors 70 are connected to each other in portions thereof. The respective dividing lines Y1, Y2, Y3, Y4, and Y5 are provided so as to go through the connected portions. When the group of liquid crystal panels 100 is divided into individual liquid crystal panels 10, adjacent corrosive liquid intrusion detectors 70 are separated from each other.

As shown in FIG. 4, there is a margin portion 201 that is not used as a liquid crystal panel 10 at an edge of the group of TFT array substrates 200. Although not shown in FIG. 4, the group of CF substrates also has a similar margin portion. However, in the present embodiment, the margin portion in the group of CF substrates is set larger than the margin portion 201.

The margin portion 201 is made of a portion outside of the dividing line X2 in the group of TFT array substrates 200, and between this margin portion and the margin portion of the group of CF substrates facing each other, a line-shaped spacer 41 is formed to fill the gap therebetween. This spacer 41 is made of the same material as the sealing member 40, and is manufactured in the same step. The spacer 41 is provided to block the etching solution from entering the group of liquid crystal panels 100 from edges thereof when thinning the group of liquid crystal panels 100 as described below.

(Step S5)

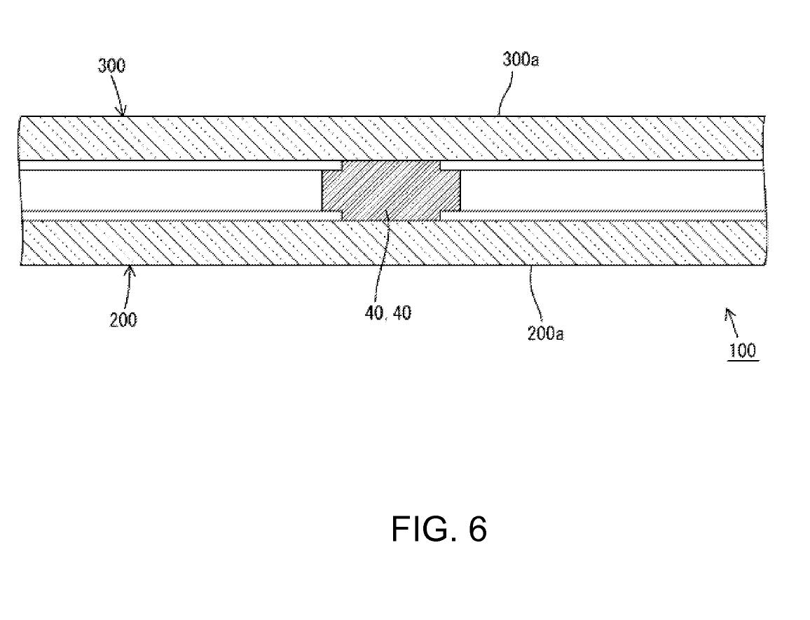

Step S5 is a step to reduce the thickness of the group of liquid crystal panels 100 by etching (first thinning step). FIG. 6 is a cross-sectional view that schematically shows an area around the sealing member 40 in the group of liquid crystal panels 100 before thinning. In step S5, the thickness of the group of liquid crystal panels 100 is reduced by etching until the thickness (plate thickness) of each of the group of TFT array substrates 200 and the group of CF substrates 300 reaches a value (T+α) that is obtained by adding a (50 μm to 100 μm, for example) to the final target thickness T (0.05 mm to 0.5 mm, for example, and more preferably 0.1 mm to 0.3 mm).

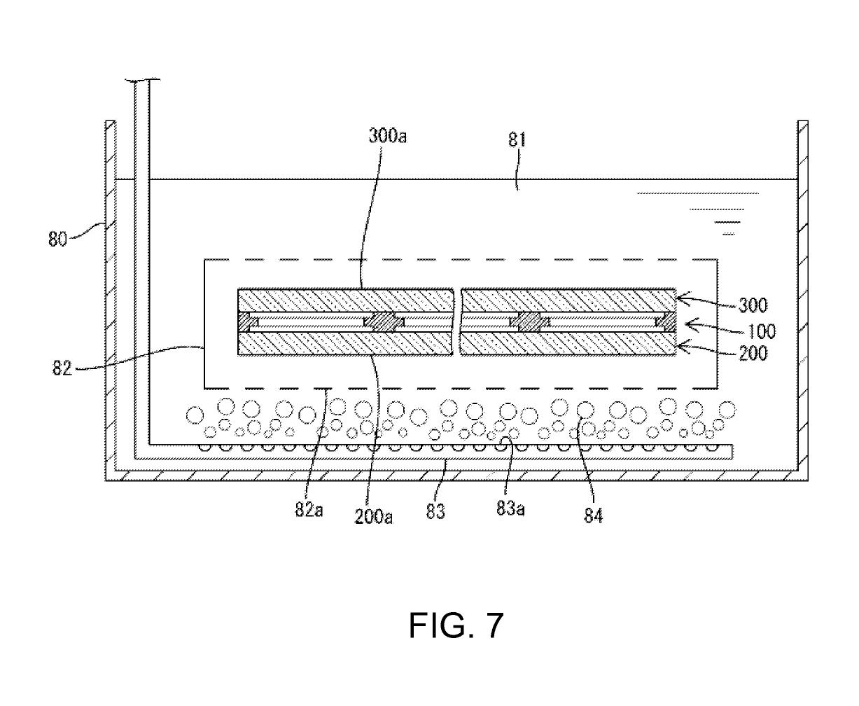

FIG. 7 is a cross-sectional view of an etching tank used for thinning the group of liquid crystal panels. As shown in FIG. 7, in this etching process, the group of liquid crystal panels 100 is immersed in an etching solution 81 that fills an etching tank 80. In this case, the group of liquid crystal panels 100 is placed in a specialized tray 82, and is immersed in the etching solution 81, being placed in the tray 82. A known solution such as hydrofluoric acid is used as the etching solution 81.

The tray 81 has a plurality of holes 82a disposed therearound, and through these holes 82a, the etching solution 81 enters the tray 82. By using the etching solution 81 that entered, the group of liquid crystal panels 100 is thinned in the tray 81.

In the lower part of (on the bottom of) the etching tank 80, an air supply pipe 83 connected to an air supply pump (not shown) is disposed. The air supply pipe 83 has numeral small holes 83a, thereby generating bubbles 84 through these small holes 83a. During the etching process, the etching solution 81 is agitated by the bubbles 84. The bubbles 84 are formed by injecting, through the small holes 83a of the air supply pipe 83, a gas such as nitrogen gas supplied from the air supply pump.

As the etching process progresses, the thickness (plate thickness) of the group of TFT array substrates 200 and the thickness (plate thickness) of the group of CF substrates 300 are made smaller (thinner) gradually. The thickness of the group of TFT array substrates 200 is gradually reduced as a result of the outer surface 200a being dissolved (etched), and the thickness of the group of CF substrates 300 is gradually reduced as a result of the outer surface 300a being dissolved (etched).

When the respective plate thicknesses of the groups of substrates 200 and 300 reach the target of this process, i.e., T+α, the group of liquid crystal panels 100 in the tray 82 is removed from the etching tank 80, and the first etching process is completed. The group of liquid crystal panels 100 is removed from the tray 82.

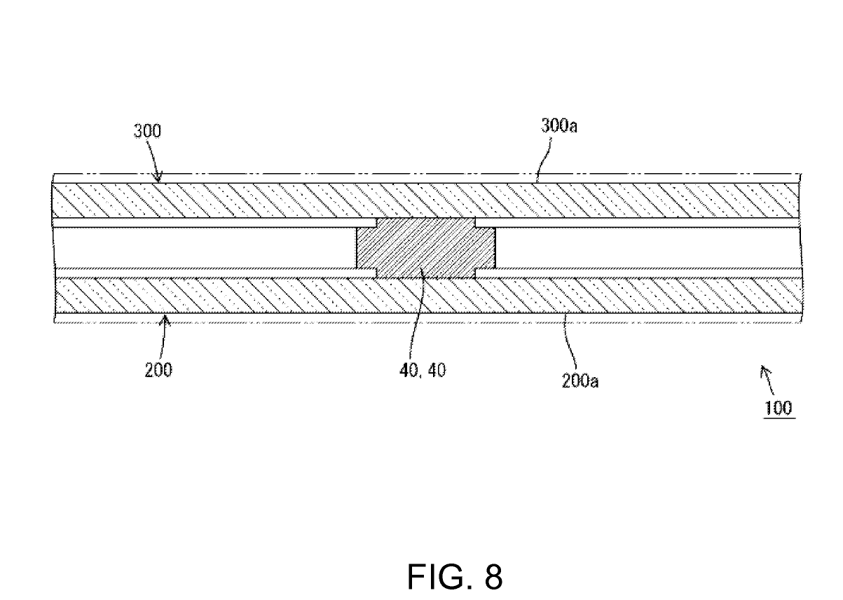

FIG. 8 is a cross-sectional view that schematically shows an area around the sealing member 40 of the group of liquid crystal panels 100 that has been thinned through the first etching process (first thinning process). In FIG. 8, the positions of outer surfaces 200a and 300a of the respective groups of substrates 200 and 300 before the etching process (thinning) are respectively indicated with chain lines. As shown in FIG. 8, the respective plate thickness of the respective groups of substrates 200 and 300 are reduced by the etching process.

(Step S6)

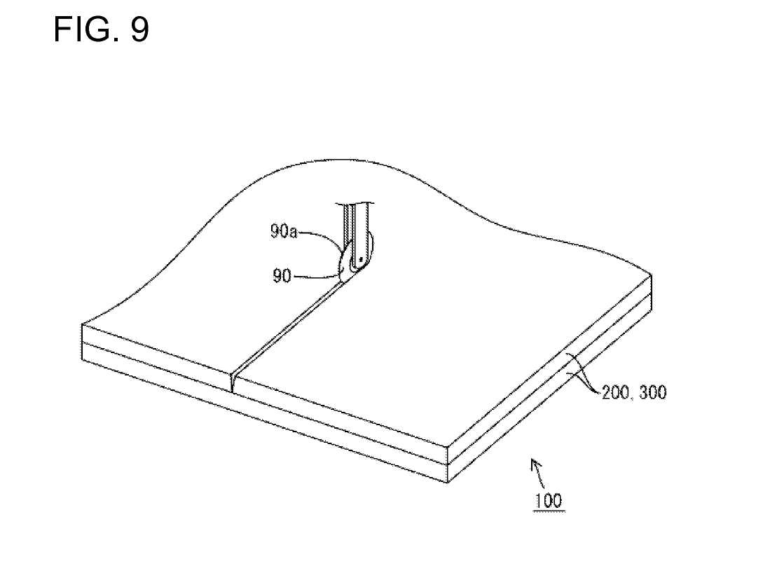

Step S6 is a step to form first scribed grooves on the group of TFT array substrates 200. FIG. 9 is a perspective view of a cutter wheel 90 used to form scribed grooves. In step S6, on the outer surface of the group of TFT array substrates 200 in the group of liquid crystal panels 100 after the etching process, scribed grooves are formed by using the cutter wheel 90 shown in FIG. 9. The cutter wheel 90 is provided with a rotary blade 90a made of a single crystal body of synthetic diamond or the like. The rotary blade 90a is tapered at the outer edge.

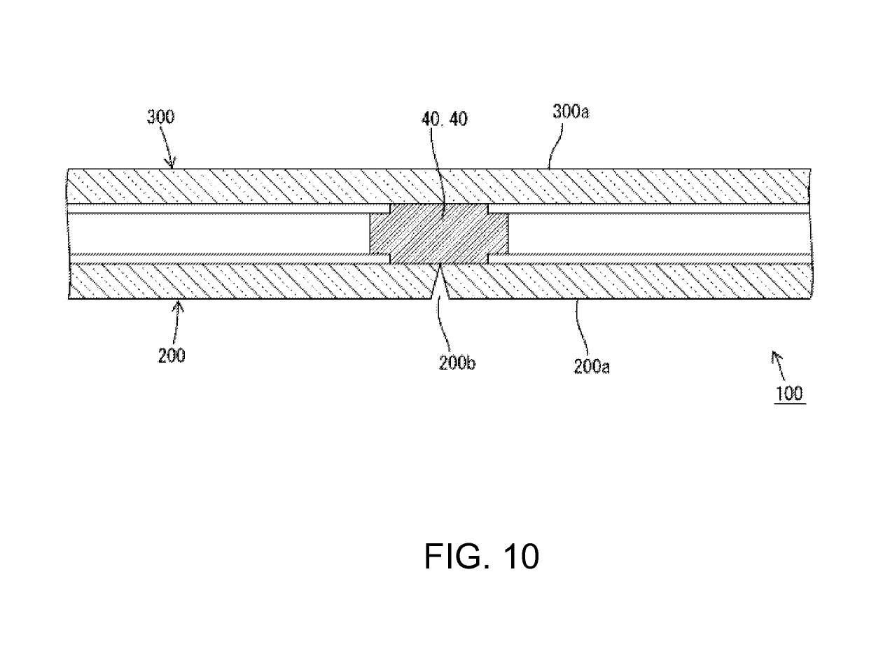

By spinning the rotary blade 90a of the cutter wheel 90 while pressing the blade against the outer surface 200a along the dividing line Y1 and the like (see FIG. 4), a scribed groove 200b having a V-shaped cross section is formed in the group of TFT array substrates 200. The scribed groove 200b formed on the outer surface 200a of the group of TFT array substrates 200 is referred to as a first scribed groove 200b in particular. FIG. 10 is a cross-sectional view that schematically shows an area around the sealing member 40 of the group of liquid crystal panels 100 in which the first scribed groove 200b is formed. As shown in FIG. 10, the first scribed groove 200b is formed in a position that is substantially the center of a portion where adjacent sealing members 40 and 40 are integrally formed.

(Step S7)

Step S7 is a step to conduct an etching process to further reduce the thickness of the group of liquid crystal panels 100 and to make the first scribed groove 200b larger (second thinning process). In step S7, the thickness a that was left in the above-mentioned step S5 (first thinning process) is removed by etching. The respective groups of substrates 200 and 300 are thinned to reach the thickness T, which is the final target.

In step S7, the group of liquid crystal panels 100 is immersed in the etching solution 81 in the etching tank 80 in a manner similar to step S5. In this case also, as the etching process progresses, the thickness (plate thickness) of the group of TFT array substrates 200 and the thickness (plate thickness) of the group of CF substrates 300 are both gradually reduced (become thinner). The thickness of the group of TFT array substrates 200 is gradually reduced as a result of the outer surface 200a being dissolved (etched), and the thickness of the group of CF substrates 300 is gradually reduced as a result of the outer surface 300a being dissolved (etched). When the group of liquid crystal panels 100 is thinned to the point where the respective thicknesses of the groups of substrates 200 and 300 each reach the thickness T, which is the ultimate target, the group of liquid crystal panels 100 in the tray 82 is removed from the etching tank 80, and the second etching process is completed. Thereafter, the group of liquid crystal panels 100 is removed from the tray 82 in an appropriate manner.

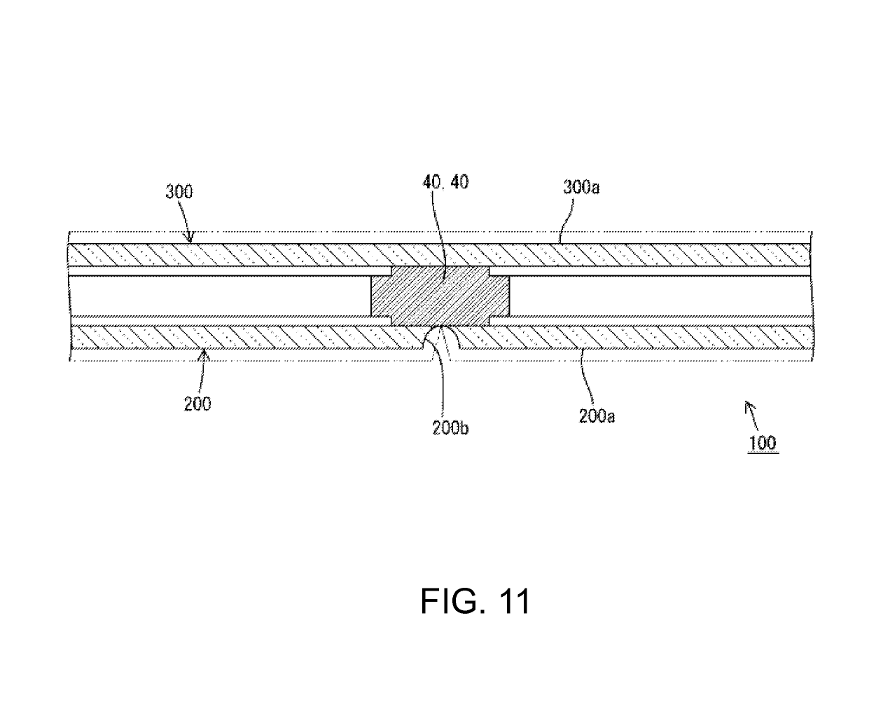

In step S7, the first scribed groove 200b formed in the outer surface 200a of the group of TFT array substrates 200 is also gradually etched. The first scribed groove 200b grows in the line width direction and in the line depth direction. FIG. 11 is a cross-sectional view that schematically shows an area around the sealing member 40 of the group of liquid crystal panels 100 that has been thinned through the second etching process. FIG. 11 shows the first scribed groove 200b that has grown by the etching process. In FIG. 11, the positions of outer surfaces 200a and 300a of the respective groups of substrates 200 and 300 before the second etching process are respectively indicated with chain lines. As shown in FIG. 11, as a result of the etching process, the thicknesses of the respective groups of substrates 200 and 300 have been respectively reduced, and the first scribed groove 200b has been made larger.

(Step S8)

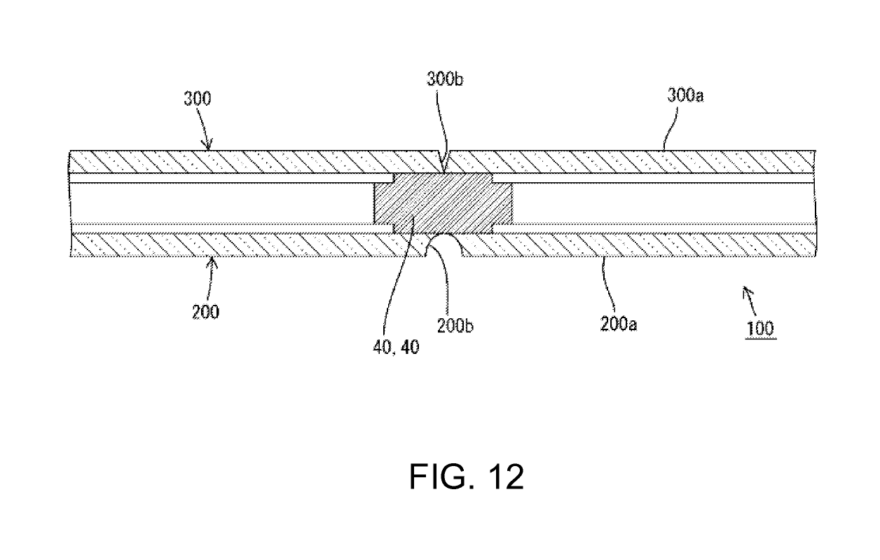

Step S8 is a step to from a second scribed groove 300b in the group of CF substrates 300. In step S8, a scribed groove is formed on the outer surface of the group of CF substrates 200 in the group of liquid crystal panels 100 after the second etching process by using the cutter wheel 90 (see FIG. 9). A plurality of dividing lines are also provided on the group of CF substrates 300 so as to partition each liquid crystal panel 10. By spinning the rotary blade 90a of the cutter wheel 90 while pressing the blade against the outer surface 300a along these dividing lines, scribed grooves 300b having a V-shaped cross section are formed in the group of CF substrates 300. The scribed groove 300b formed on the outer surface 300a of the group of CF substrates 300 is referred to as a second scribed groove 300b in particular. FIG. 12 is a cross-sectional view that schematically shows an area around the sealing member 40 of the group of liquid crystal panels 100 in which the second scribed groove 300b is formed. As shown in FIG. 11, the second scribed groove 300b is formed in a position that is substantially the center of a portion where adjacent sealing members 40 and 40 are integrally formed. The first scribed groove 200b and the second scribed groove 300b face each other through the portion where adjacent sealing members 40 and 40 are integrally formed.

(Step S9)

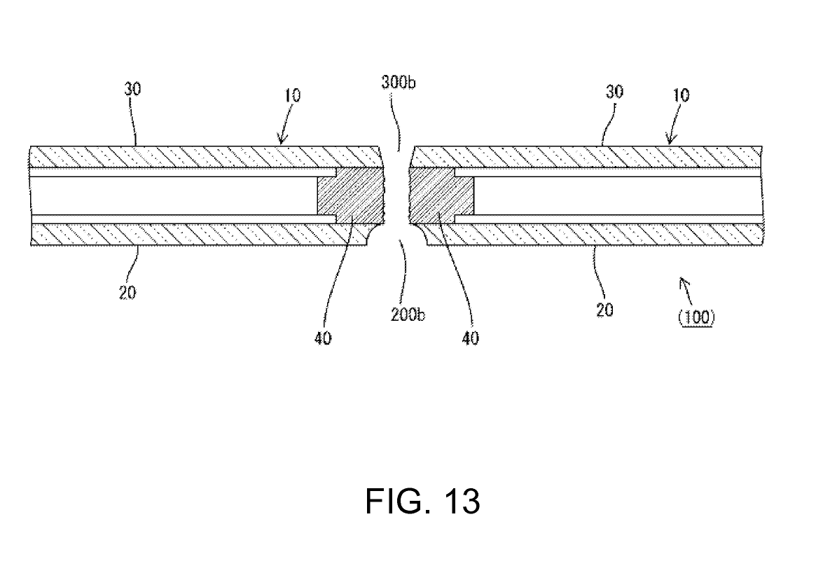

Step 9 is a step to divide the group of liquid crystal panels 100 into individual liquid crystal panels 10. In step 9, in step 9, a prescribed force is applied externally to the group of liquid crystal panels 100 (see FIG. 12) in which the first scribed groove 200b and the second scribed groove 300b are formed. When receiving the external force, portions with a reduced thickness (smaller thickness) as a result of the first scribed groove 200b and the second scribed groove 300b being formed therein are sheared. At this time, the portion in which adjacent sealing members 40 and 40 are integrally formed is separated. FIG. 13 is a cross-sectional view that schematically shows liquid crystal panels 10 and 10 obtained by shearing the group of liquid crystal panels 100. As shown in FIG. 13, by being sheared and separated at the portion where the first scribed groove 200b and the second scribed groove 300b are formed, the group of liquid crystal panels 100 is divided into individual liquid crystal panels 10. The margin portion 201 and the like in the group of liquid crystal panels 100 as shown in FIG. 4 are also sheared away in step S9.

In the present embodiment, respective corrosive liquid intrusion detectors 70 and 70 in adjacent liquid crystal panels 10 and 10 are also integrally formed with each other in portions thereof as described above (see FIG. 4). Therefore, in step S9, the respective corrosive liquid intrusion detectors 70 and 70 are also sheared and separated from each other. In this manner, the corrosive liquid intrusion detector 70 provided in the liquid crystal panel 10 in the end is formed at outer edges of the TFT array substrate 20 without breaks, thereby being suitable to a detection of the etching solution described below.

In the manner described above, in step S9, the group of liquid crystal panels 100 is divided, and a plurality of liquid crystal panels 10 are obtained from the group of liquid crystal panels 100. Edges (end faces) of each liquid crystal panel 10 are appropriately shaped.

(Step S10)

Step 10 is a step to remove a liquid crystal panel 10 with a discolored corrosive liquid intrusion detector 70. As described above, before the group of liquid crystal panels 100 is divided into individual liquid crystal panels 10, two etching processes are conducted. In the second etching process, in particular, the first scribed groove 200b is made larger. When the first scribed groove 200b is made larger as such, in some cases, the groove reaches the other end or the like, thereby forming a hole that penetrates the group of TFT array substrates 200 (penetrating hole). If this hole is formed immediately above the sealing member 40, for example, the hole is blocked by the sealing member 40, and therefore, the etching solution does not enter a space inside of the group of liquid crystal panels 100 through the hole. However, if such a hole is formed in a portion where the sealing member 40 is not formed (on the dividing line X2, for example), the etching solution can enter the space inside of the group of liquid crystal panels 100 through the hole. In particular, if the etching solution enters the space inside of the group of TFT array substrates 200, and makes contact with the terminal pattern 60 formed in each TFT array substrate 20, the corrosion of the terminal pattern 60 results. Because the corrosion of the terminal pattern 60 causes connection defects and the like, a liquid crystal panel 10 with a corroded terminal pattern 60 cannot be used as is. Therefore, it is necessary to sort out such a liquid crystal panel 10 from other liquid crystal panels that do not have corroded terminal patterns 60.

Because the respective wiring lines constituting the terminal pattern 60 are very thin, if only one portion thereof is corroded by the etching solution, it would be possible that the corrosion is overlooked in a visual inspection. However, each liquid crystal panel 10 of the present embodiment is provided with the corrosive liquid intrusion detector 70 as described above, and therefore, it is possible to find the corrosion of the terminal pattern 60 by a visual inspection with ease. The reason for that will be explained below.

The corrosive liquid intrusion detector 70 is disposed on the inner surface of the TFT array substrate 20 in a position closer to the outside (outer edge) than the terminal pattern 60. The corrosive liquid intrusion detector 70 is disposed on the inner surface of the TFT array substrate 20 along the edges (outer edges) of the liquid crystal panel 10. Generally, the etching solution enters from the edges of the liquid crystal panel 10, and therefore, if the terminal pattern 60 is corroded by the etching solution, it means that the etching solution has passed the corrosive liquid intrusion detector 70 that is disposed outside of the terminal pattern 60.

The corrosive liquid intrusion detector 70 has a metal film on the uppermost layer (outermost layer) thereof (see FIG. 3). In the present embodiment, the metal film is made of transparent ITO. On contact with the etching solution (corrosive liquid), the metal film reacts with the etching solution, and the color of the metal film changes (discoloration occurs).

Therefore, if the color of the corrosive liquid intrusion detector 70 has changed, there is a possibility that the etching solution has reached the terminal pattern 60 disposed inside thereof, and one can assume that the corrosion of the terminal pattern 60 occurred. As described above, whether the corrosion of the terminal pattern 60 has occurred or not can be determined based on the discoloration of the corrosive liquid intrusion detector 70.

The corrosive liquid intrusion detector 70 has the base film 72 under the metal film 71, which reduces the light transmittance (transparency) to some extent, and therefore, the discoloration of the metal film 71 is made easier to see.

As described above, it is possible to easily find a liquid crystal panel 10 with a corroded terminal pattern 60 from a plurality of liquid crystal panels 10 by a visual inspection. Examples of the visual inspection include directly checking the discoloration of the corrosive liquid intrusion detector 70 with human eyes, and using tools such as a magnifier or a CCD camera.

Thus, in step S9, a liquid crystal panel 10 with a discolored corrosive liquid intrusion detector 70 can be separated from other liquid crystal panels 10 with ease. The base film 72 of the corrosive liquid intrusion detector 70 also improves the adhesion of the metal film 71 to the plate 2.

As described above, with the manufacturing method for a liquid crystal panel according to the present embodiment, a liquid crystal panel 10 in which the terminal pattern 60 corroded due to the etching solution can be found with ease. Therefore, with the manufacturing method for a liquid crystal panel of the present embodiment, by removing a liquid crystal panel 10 in which the terminal pattern 60 corroded due to the etching solution, it is possible to efficiently manufacture liquid crystal panels 10 with acceptable quality only.

The corrosive liquid intrusion detector 70 in the liquid crystal panel 10 of the present embodiment can be made by using an existing manufacturing process. Thus, in the liquid crystal panel 10 of the present embodiment, it is not necessary to add substantially new manufacturing steps to make the corrosive liquid intrusion detector 70, and therefore, it is possible to prevent a cost increase resulting from adding the corrosive liquid intrusion detector 70.

In addition to the hole formed in the group of TFT array substrates 200, intrusion paths of the etching solution may also be a hole formed in the group of CF substrates 300, a gap at an edge of the group of liquid crystal panels 100 (in other words, a gap between the groups of substrates 200 and 300), and the like.

### Embodiment 2

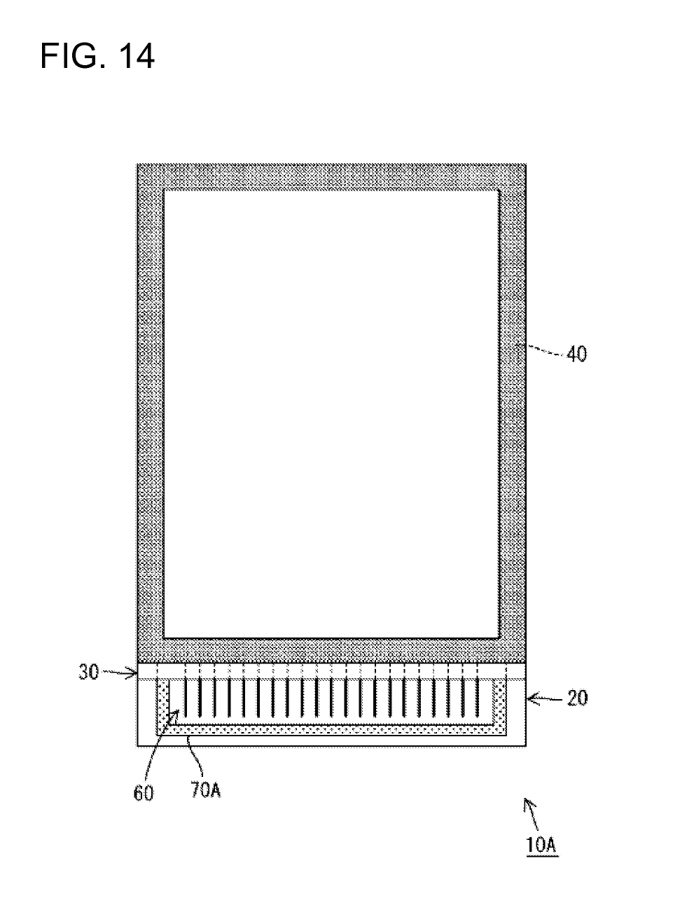

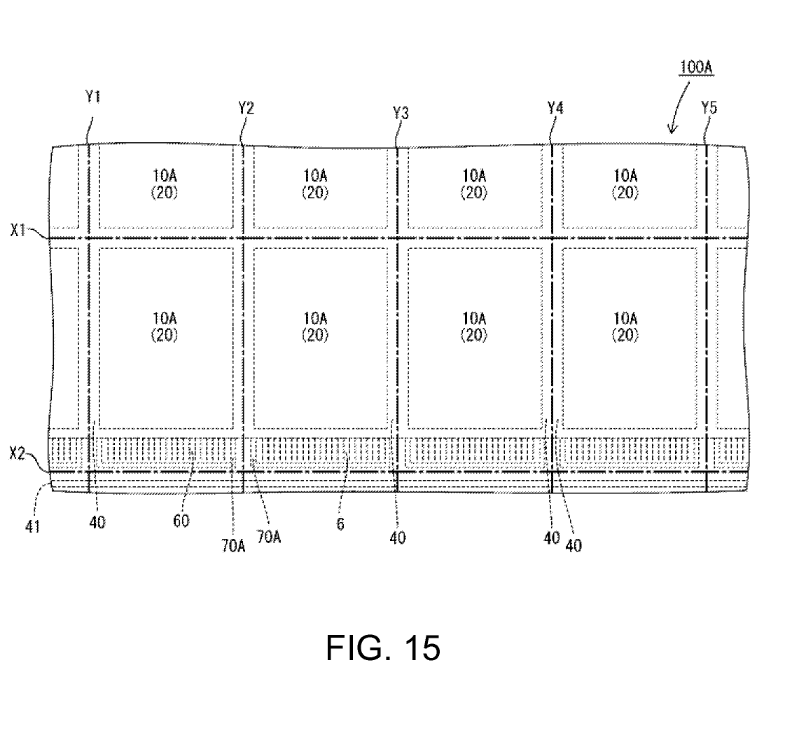

Next, with reference to FIGS. 14 and 15, Embodiment 2 of the present invention will be explained. FIG. 14 is a plan view of a liquid crystal panel 10A of Embodiment 2, and FIG. 15 is a plan view of a group of liquid crystal panels 100A of Embodiment 2. FIG. 15 shows the group of liquid crystal panels 100A when viewed from the side where the group of TFT array substrates 200 is disposed, as in the group of liquid crystal panels of Embodiment 1 shown in FIG. 4. The basic configurations and manufacturing method for the liquid crystal panel 10A and the group of liquid crystal panels 100A of the present embodiment are the same as those in Embodiment 1. However, in the present embodiment, the shape (pattern) of a corrosive liquid intrusion detector 70A provided in the liquid crystal panel 10A differs from that in Embodiment 1. The difference will be mainly explained below.

As shown in FIG. 14, the corrosive liquid intrusion detector 70A is disposed outside of the terminal pattern 60 on the inner surface of the TFT array substrate 20 in a manner similar to Embodiment 1. However, the corrosive liquid intrusion detector 70A of the present embodiment is disposed inside of the outer edges of the TFT array substrate 20. As shown in FIG. 15, respective corrosive liquid intrusion detectors 70A in adjacent liquid crystal panels 10A are formed in the group of TFT array substrates 200 in advance so as to be separated from each other. As described above, the corrosive liquid intrusion detector 70A does not necessarily have to be formed to cover the outer edges of the TFT array substrate 20 as long as the corrosive liquid intrusion detector 70A is formed outside of the terminal pattern 60.

### Embodiment 3

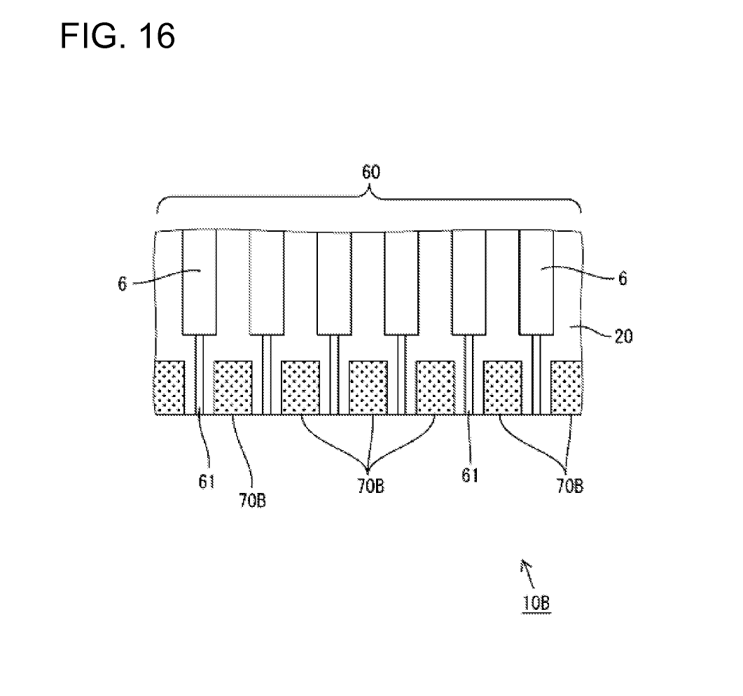

Next, with reference to FIG. 16, Embodiment 3 of the present invention will be explained. FIG. 16 is an enlarged plan view of a part of a corrosive liquid intrusion detector 70B formed in a liquid crystal panel 10B of Embodiment 3. The basic configurations and manufacturing method of the liquid crystal panel 10B of the present embodiment are the same as those in Embodiment 1. However, in the liquid crystal panel 10B of the present embodiment, the shape (pattern) of a corrosive liquid intrusion detector 10B provided on the inner surface of the TFT array substrate 20 differs from that in Embodiment 1. The difference will be mainly explained below.

As shown in FIG. 16, the corrosive liquid intrusion detector 70B of the present embodiment is disposed outside of the terminal pattern 60 on the inner surface of the TFT array substrate 20 in a manner similar to Embodiment 1. However, the corrosive liquid intrusion detector 70B is divided into a plurality of sections in portions along the outer edges of the TFT array substrate 20. In other words, the corrosive liquid intrusion detector 70B of the present embodiment is formed in a shape that has breaks in places, instead of the continuous shape as in Embodiment 1. As described above, the corrosive liquid intrusion detector 70B in the liquid crystal panel 10B does not necessarily have to have a continuous shape, but may be formed in a shape that has breaks in places.

In the present embodiment, at an end of each wiring line 6 constituting the terminal pattern 60, a marker 61 is provided. The marker 61 is formed to be even narrower than the wiring line 6. When other patterns (markers 61) are formed on the inner surface of the TFT array substrate 20 as described above, the corrosive liquid intrusion detector 10B may be formed so as to avoid those patterns.

### Embodiment 4

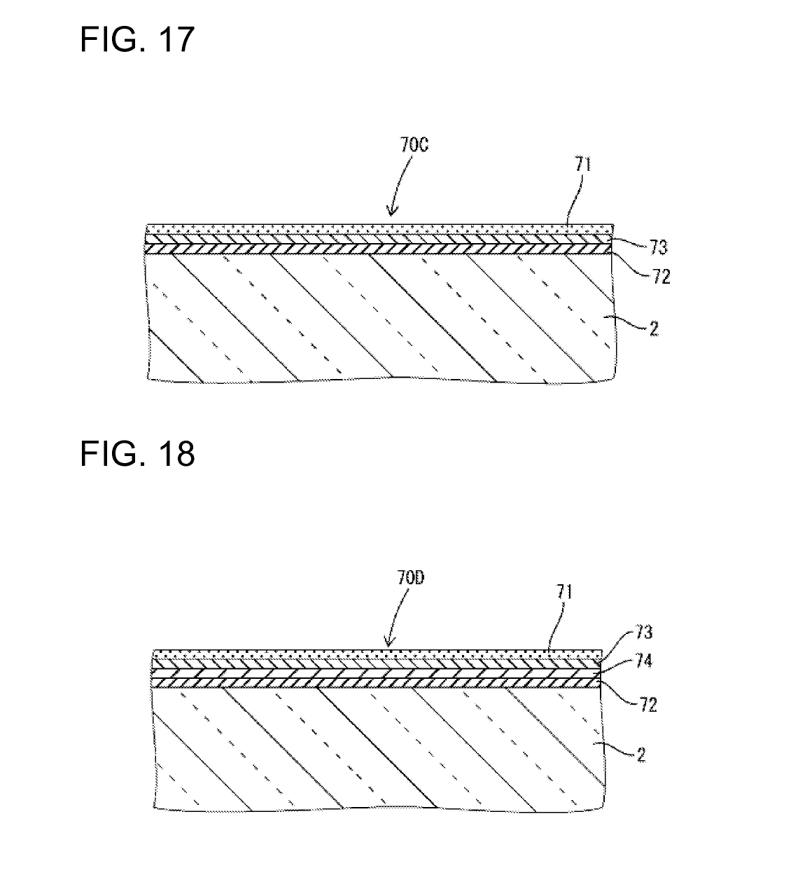

Next, with reference to FIG. 17, Embodiment 4 of the present invention will be explained. FIG. 17 is an enlarged cross-sectional view of a part of a corrosive liquid intrusion detector 70C formed in a liquid crystal panel of Embodiment 4. The basic configurations and manufacturing method of the liquid crystal panel of the present embodiment are the same as those in Embodiment 1. However, the configuration of the corrosive liquid intrusion detector 70C differs from that in Embodiment 1. The difference will be mainly explained below.

The corrosive liquid intrusion detector 70C of the present embodiment has a metal film 71 in the uppermost layer (outermost layer) thereof, as in Embodiment 1. On the glass plate 2, a base film 72 is formed. However, in the corrosive liquid intrusion detector 70C of the present embodiment, an intermediate film 73 is provided therebetween. The intermediate film 73 is made of the same material as the source electrode lines 23 (see FIG. 1), and is formed in the same manufacturing step. When the intermediate film 73 is formed between the metal film 71 and the base film 72 as described above, the light transmittance (transparency) is reduced by the intermediate film 73, and therefore, it becomes easier to see the discoloration of the corrosive liquid intrusion detector 70C.

### Embodiment 5

Next, with reference to FIG. 18, Embodiment 5 of the present invention will be explained. FIG. 18 is an enlarged cross-sectional view of a part of a corrosive liquid intrusion detector 70D formed in a liquid crystal panel of Embodiment 5. The basic configurations and manufacturing method of the liquid crystal panel of the present embodiment are the same as those in Embodiment 1. However, the configuration of the corrosive liquid intrusion detector 70D differs from that in Embodiment 1. The difference will be mainly explained below.

The corrosive liquid intrusion detector 70D of the present embodiment has a metal film 71 in the uppermost layer (outermost layer) thereof, as in Embodiment 1. On the glass plate 2, a base film 72 is formed. However, in the corrosive liquid intrusion detector 70D of the present embodiment, two (two layers of) intermediate films 73 and 74 are provided between the two films. The intermediate film 73 is disposed on an upper side, and the intermediate film 74 is disposed on the lower side. The intermediate film 73 is made of the same material as the source electrode lines 23 (see FIG. 1), and is formed in the same manufacturing step. The intermediate film 74 is made of the same material as the gate electrode lines 74 (see FIG. 1), and is formed in the same manufacturing step. When the two intermediate films 73 and 74 are formed between the metal film 71 and the base film 72 as described above, the light transmittance (transparency) is reduced by these intermediate films 73 and 74, and therefore, it becomes easier to see the discoloration of the corrosive liquid intrusion detector 70D.

### Other Embodiments

The present invention is not limited to the embodiments shown in the drawings and described above, and the following embodiments are also included in the technical scope of the present invention, for example.

(1) In the respective embodiments above, the metal film in the corrosive liquid intrusion detector was formed on the glass plate through the base film, but in another embodiment, the metal film may formed directly on the glass plate.

(2) In the respective embodiments above, the corrosive liquid intrusion detector was left in the liquid crystal panel after the final process, but in another embodiment, the corrosive liquid intrusion detector may be configured to be removed from the TFT array substrate in the end, for example.

(3) In the respective embodiments above, respective liquid crystal panels in the group of liquid crystal panels were connected to each other without a gap therebetween (see FIG. 4, for example), but in another embodiment, the liquid crystal panels may be connected to each other through a margin portion, for example. In this case, respective sealing members in adjacent liquid crystal panels may be separated from each other in advance in the group of liquid crystal panels, or may be formed with a greater width such that a part thereof is left in the margin portion after dividing the group of liquid crystal panels.

(4) In the respective embodiments above, the corrosive liquid intrusion detector was provided with a metal film, but in another embodiment, instead of a metal film, a film that changes color on contact with the etching solution may be used for the corrosive liquid intrusion detector.

(5) In the respective embodiments above, after forming the first scribed groove in the group of TFT array substrates, the second thinning process (second etching process) was conducted, and after the second scribed groove was formed in the group of CF substrates, the group of panels was divided into individual liquid crystal panels. However, in another embodiment, it is also possible to employ a configuration in which a scribed groove is first formed in the group of CF substrates, and after the second thinning process is conducted, and after a scribed groove is formed in the group of TFT array substrates, the group of panels is divided into individual liquid crystal panels. That is, in another embodiment, the second scribed groove may be formed before the first scribed groove.

(6) In yet another embodiment, scribed grooves may be formed in both the group of TFT array substrates and the group of CF substrates, and after the second thinning process, the group of panels may be divided into individual liquid crystal panels. That is, in yet another embodiment, the first scribed groove and the second scribed groove may be formed in the respective groups of substrates before the second thinning process.

### DESCRIPTION OF REFERENCE CHARACTERS

10 liquid crystal panel

2 glass plate

20 TFT array substrate (glass substrate)

21 pixel electrode (transparent electrode)

21a contact hole

22 gate electrode line

23 source electrode line

23a source electrode

23b drain electrode

24 TFT

25 semiconductor film

26 gate insulating film (insulating film)

27 interlayer insulating film

28 alignment film

30 CF substrate

3 glass plate

31 common electrode

32 BM

33 CF layer

34 alignment film

40 sealing member

50 liquid crystal layer

60 terminal pattern

70 corrosive liquid intrusion detector

100 group of liquid crystal panels

200 group of TFT array substrates (mother glass substrate)

300 group of CF substrates (mother glass substrate)

1. A liquid crystal panel, comprising:
a liquid crystal layer;
a sealing member surrounding the liquid crystal layer;
a pair of glass substrates facing each other through the liquid crystal layer and the sealing member;
a terminal pattern disposed outside of the sealing member on an inner surface of one of the glass substrates; and
a corrosive liquid intrusion detector disposed outside of the terminal pattern on said inner surface, the corrosive liquid intrusion detector changing color on contact with a corrosive liquid.

2. The liquid crystal panel according to claim 1, wherein the corrosive liquid intrusion detector includes a metal film.

3. The liquid crystal panel according to claim 1, wherein the corrosive liquid intrusion detector includes a metal film and a base film disposed under the metal film.

4. The liquid crystal panel according to claim 1, wherein the corrosive liquid intrusion detector includes a metal film, a base film, and one intermediate film or two or more intermediate films therebetween.

5. The liquid crystal panel according to claim 2, wherein the metal film is made of the same material as a transparent electrode disposed on an inner surface of one of the glass substrates, and is formed in the same forming step as the transparent electrode.

6. The liquid crystal panel according to claim 3, wherein the base film is made of the same material as an insulating film disposed on an inner surface of one of the glass substrates, and is formed in the same forming step as the insulating film.

7. The liquid crystal panel according to claim 4, wherein the intermediate film is be made of the same material as a gate electrode or a source electrode disposed on an inner surface of one of the glass substrates, and is formed in the same forming step as the gate electrode or the source electrode.

8. The liquid crystal panel according to claim 1, wherein the corrosive liquid intrusion detector surrounds the terminal pattern together with the sealing member.

9. A group of liquid crystal panels that is used for collectively manufacturing a plurality of said liquid crystal panels according to claim 1, comprising:
one mother glass substrate made of a plurality of one type of glass substrates interconnected to each other;
another mother glass substrate made of a plurality of another type of glass substrates interconnected to each other;
a plurality of liquid crystal layers interposed between the mother glass substrates;
a plurality of sealing members interposed between the mother glass substrates;
a plurality of terminal patterns disposed on an inner surface of the one mother glass substrate; and
a plurality of corrosive liquid intrusion detectors disposed on the inner surface of said one mother glass substrate.

10. A manufacturing method for liquid crystal panels, comprising:
forming a scribed groove on an outer surface of at least one mother glass substrate to divide the group of liquid crystal panels according to claim 9 into individual liquid crystal panels;
exposing the scribed groove to a corrosive liquid to make the scribed groove larger;
dividing the group of liquid crystal panels into individual liquid crystal panels along the scribed groove that has been made larger; and
removing a liquid crystal panel in which a corrosive liquid intrusion detector has discolored due to the corrosive liquid from the divided individual liquid crystal panels.
